(19) United States
(12) Patent Application Publication
(10) Pub. No.: US 2003/0041489 A1
(43) Pub. Date: Mar. 6, 2003

(54) Drinking cup identification system

(76) Inventors: Sean Murphy, Elmhurst, IL (US); Catherine Murphy, Elmhurst, IL (US)

Correspondence Address: Peter A. Borsari, Esq., Borsari & Associates, P.C., Suite 206, 2001 Jefferson Davis Highway, Arlington, VA, 22202, US

(21) Appl. No.: 09/946,333

(22) Filed: Sep. 6, 2001

(51) Int. Cl. G09F 3/00

(52) U.S. Cl. 40/324

(57) ABSTRACT

A drinking cup identification system comprises a set of a plurality of drinking cups, particularly children's spill-proof drinking cups, each of the drinking cups being provided with a unique identifying indicia selected from a sequential pattern of indicia. The use of the sequential pattern of indicia enables the user to plainly identify each of the drinking cups and to easily monitor and visually track the set of drinking cups to determine whether any of the drinking cups is missing from the set. The unique identifying indicia can be any indicia which can be classified into a sequential pattern, including a series of numbers, alphabet letters and the like. The unique identifying indicia can be adhesively applied to each drinking cup, such as by labels, or can be machine molded, etchingly inscribed or printed onto each drinking cup.

### FIELD OF INVENTION

The present invention relates to a drinking cup identification system, particularly an identification system for tracking a set of a plurality of a child's drinking cups. More specifically, the present invention relates to an identification system in which each of the plurality of drinking cups of a particular set is provided with a unique identifying indicia selected from a sequential pattern of indicia. The sequential pattern of indicia, which can be in a variety of forms, enables the user to plainly identify each of the plurality of drinking cups and also to visually track the set of drinking cups by quickly determining whether one or more of the plurality of drinking cups is missing from a particular set.

### BACKGROUND OF THE INVENTION

Lidded drinking cups, particularly baby bottles and “sippy” cups, commonly are used to serve beverages to toddlers. These types of drinking cups usually are provided with securely fastened lids, thereby making them “spill-proof”. As a result, they are ideally suitable for toddlers. Because a parent (or other care-giver) can give the toddler his/her beverage in such a drinking cup without worrying about the child spilling the beverage, the toddler can consume the beverage without supervision. Typically, the toddler will carry the drinking cup to other rooms of a house or even outside. The toddler also can use the drinking cup while secured in a car seat, the parent knowing that the risk of spillage is minimal. However, a disadvantage to the use of these lidded drinking cups is that when the toddler tires of drinking the beverage or becomes distracted, he/she drops, hides or otherwises misplaces the cup. Certain problems can arise when the misplaced drinking cup still contains some beverage. For instance, when a drinking cup is left in a hot car or other hot environment, the remaining beverage can ferment quickly and emit a strong, unpleasant odor. More importantly, if the toddler finds the misplaced drinking cup, hours or even days, after it was initially used, the remaining beverage may have spoiled and possibly may have become toxic. Thus, if the child drinks the spoiled beverage, the child could become severely ill. Currently, there is no identification system for visually tracking these lidded drinking cups in order to prevent a toddler from accidently drinking a spoiled and potentially hazardous beverage from a misplaced drinking cup.

Drinking cups having ornamental designs, including mugs, baby bottles, and “sippy” cups, are well known in the prior art. Many such drinking cups are provided with ornamental designs purely to enhance the aesthetic nature of the cups. The use of advertising logos, pithy quips, souvenir memorabilia and the like as ornamental designs for drinking cups also is conventional practice. For instance, U.S. Pat. No. 566,761 to Hosmer, issued Sep. 1, 1896 discloses the use of an advertising label which is applied about the circumference of a bottle.

It is also well known to provide cartoon characters, animals and other inviting designs on children's drinking cups. For example, U.S. Pat. No. 2,156,351 to Paul, issued May 2, 1939, provides a child's feeding bowl or drinking cup having a display frame on its bottom surface which is capable of receiving a picture, thereby induce children who are poor eaters to consume the entire contents of the bowl in order to see the picture. Similarly, U.S. Pat. No. 3,514,887 to Jacob, issued Jun. 2, 1970, discloses a child's feeding utensil or cup having a transparent bottom with a slot for receiving a visual display card to induce the child to finish the contents of the utensil. In U.S. Pat. No. 5,729,922 to Peterson et al., issued Mar. 24, 1998, a drinking vessel is disclosed having an open face slot on its outer surface for holding a selected tile from a plurality of interchangeable tiles bearing indicia for conveying a selected design or message. However, none of these drinking vessels provides a parent or other care-giver with a visual identification system for tracking a plurality of drinking cups.

Identification systems have been developed for distinguishing a particular drinking cup. For example, Canadian Patent 491,642 to Vallee, issued Mar. 31, 1953, discloses a set of identification plates, each plate being in the form of a clip bearing a particular indicia which is snapped onto the rim of a drinking glass. U.S. Pat. No. 5,261,176 to David et al., issued Nov. 16, 1993, discloses the use of beverage identification tags for cup handles, particularly for use in the restaurant service industry, the tag being coded to indicate the kind of beverage within the cup. However, such identification clips and tags are incompatible with lidded drinking cups which have no exposed rim or cup handle. In addition, the use of a detachable identification means is impractical and unsuitable for toddlers who have a natural tendency to detach and lose or possibly swallow such small objects such as the Vallee clips or David et al. tags.

U.S. Pat. No. 5,191,979 to Nemeroff, issued Mar. 9, 1993, discloses a set of drinking cups and a series of labels having identifying indicia, each cup having one identifying label applied thereto in order to distinguish one cup from another. In related U.S. Pat. No. 5,301,802 to Nemeroff, issued Apr. 12, 1994, a set of drinking cups is provided with two sets of labels having identifying indicia, the first set of labels is applied to the individual drinking cups in order to distinguish each cup. The second set of labels, which correspond to the first set, are used to identify the individual having a particular cup. Although the Nemeroff patents provide labels with identifying indicia which could be applied to a child's drinking cup, neither Nemeroff patent provides an identification system which allows a parent or other care-giver to visually track a plurality of drinking cups.

Despite the attempts of the prior art, a need still exists for an identification system for use with drinking cups which enables a user to visually track a set of a plurality of such drinking cups. Such an identification system should not only be capable of identifying each of a plurality of drinking cups but should also be capable of visually tracking each of the drinking cups. Such visual tracking should include determining when each drinking cup was used and whether any of the plurality of drinking cups are missing from a particular set. Moreover, such an identification system should be permanently affixed to each of the plurality of drinking cups so that a toddler cannot detach or otherwise remove the identification means. In addition, such an identification system should be aesthetically appealing to toddlers. Such an identification system also should be inexpensive to manufacture and be capable of being used on existing lidded drinking cups. Optionally, such an identification system should be designed as a learning aid for toddlers.

### SUMMARY OF THE INVENTION

Accordingly, it is an object of the present invention to provide an identification system for a set of a plurality of drinking cups, particularly children's drinking cups, in which each of the plurality of drinking cups is provided with a unique identifying indicia.

It also is an object of the present invention to provide an identification system for a set of a plurality of drinking cups which enables the user to visually track each of the plurality of drinking cups in a particular set.

It is an additional object of the present invention to provide an identification system for a set of a plurality of drinking cups which enables the user to determine when each of the drinking cups was last used and whether any of the drinking cups from a set is missing.

It is a further object of the present invention to provide an identification system for a set of a plurality of drinking cups in which a unique identifying indicia is permanently affixed to each of the plurality of drinking cups.

It is another object of the present invention to provide an identification system for a set of a plurality of drinking cups which utilizes a sequential pattern of indicia in order to visually track each of the drinking cups in a particular set.

It is still another object of the present invention to provide an identification system for a set of a plurality of drinking cups wherein the unique identifying indicia affixed to the drinking cups is aesthetically appealing to toddlers.

It is yet another object of the present invention to provide an identification system for a set of a plurality of drinking cups which also functions as a learning aid.

It is an additional object of the present invention to provide an identification system for a set of a plurality of drinking cups which is inexpensive to manufacture and simple capable of being used on existed drinking cups.

Additional objects, advantages and novel features of the invention will be set forth in part in the description and claims which follow, and in part will become apparent to those skilled in the art upon examination of the following specification and claims or may be learned by practice of the invention.

These and other objects of the present invention are achieved by providing an identification system for a set of a plurality of drinking cups, wherein each of the plurality of drinking cups is provided with a unique identifying indicia selected from a sequential pattern of indicia.

### BRIEF DESCRIPTION OF THE DRAWINGS

The present invention will be better understood with reference to the appended drawing sheets, wherein:

FIG. 1 shows a plurality of baby bottles having a sequential pattern of indicia in the form of numbers.

FIG. 2 shows a plurality of sippy cups having a sequential pattern of indicia in the form of the days of the week.

FIG. 3 shows a plurality of sippy cups having a sequential pattern of indicia in the form of letters which spell the name of a children's character on both the cup body and the cup lid.

FIG. 4 shows a plurality of sippy cups having a combination of sequential patterns of indicia in the form of shapes and numerals.

FIG. 5A shows a set of self-adhesive labels having a sequential pattern of indicia in the form of numbers for application to a plurality drinking cups.

FIG. 5B shows a drinking cup having a unique identifying indicia in the form of the self-adhesive labels applied thereto.

FIG. 6 shows a drinking cup in which a unique identifying indicia is molded within the drinking cup.

FIG. 7 shows a drinking cup in which a unique identifying indicia is.

### DETAILED DESCRIPTION

The present invention relates to a drinking cup identification system, particularly an identification system for monitoring and visually tracking a set of drinking cups. More specifically, the present invention relates to an identification system for a set of drinking cups comprising a plurality of drinking cups wherein each of the plurality of drinking cups is provided with a unique identifying indicia selected from a sequential pattern of indicia. It is to be understood that the term “drinking cups” is meant to include any type of lidded drinking cup, particularly any type of lidded drinking cup which is used by babies and toddlers. Suitable drinking cups include, for example, baby bottles, “sippy cups” and child-sized plastic cups with snap-on covers or screw-on covers.

The identification system utilizes a plurality of unique identifying indicia which can be classified into a sequential pattern. Thus, any type of indicia which can be classified into a sequential pattern is suitable for use in the present invention. Suitable such unique identifying indicia include, for example, a series of numbers (1, 2, 3, 4, 5, 6, 7), a series of letters (A, B, C, D, E, F, G), a series of letters which spell a name, such as a child's name or a children's cartoon character, the days of the week (Monday, Tuesday, Wednesday . . . ), a series of related cartoon characters, such as the seven dwarfs, the Winnie the Pooh and friends characters, a series of specified shapes (such as geometric shapes), symbols or designs, including for example, flowers, a train having an engine, caboose and several distinct cars, as well as words, phrases and any combination of such unique identifying indicia that can be classified into a sequential pattern.

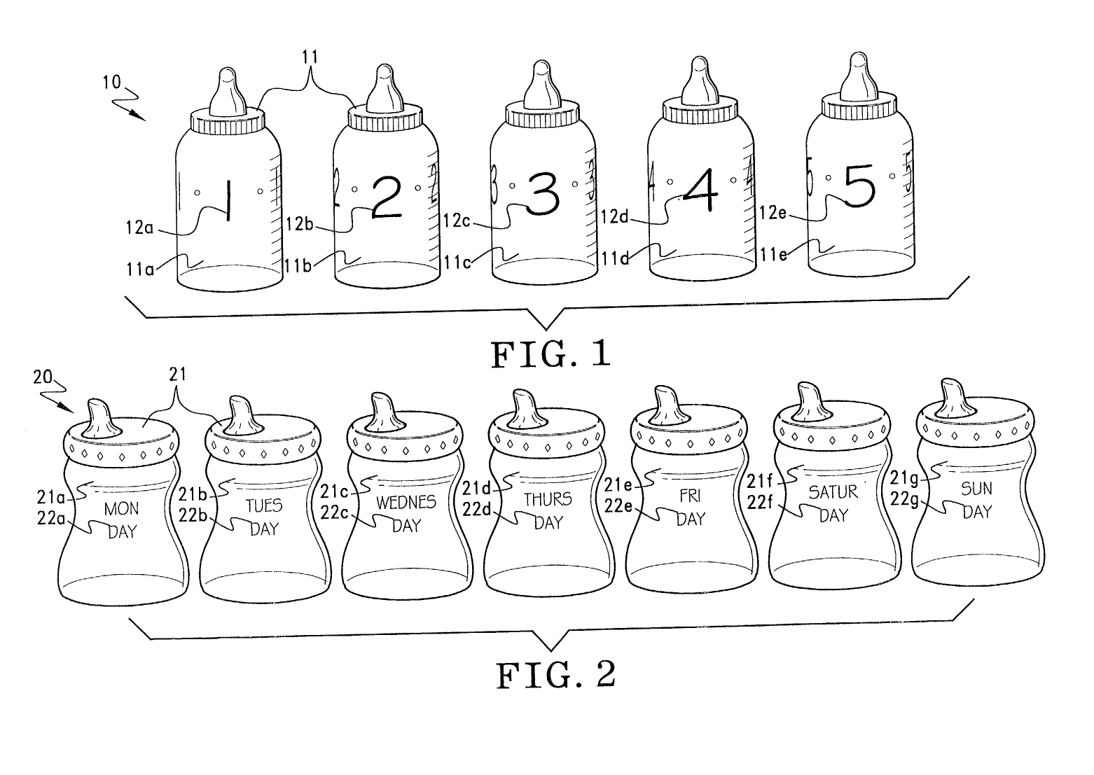

Referring to FIG. 1, a set 10 of baby bottles 11 is shown, each baby bottle being provided with a unique identifying indicia 12 in the form of a sequential pattern of numbers. More specifically, a plurality of baby bottles 11a, 11b, 11c, 11d and 11e is shown, each of the plurality of baby bottles being provided with a unique identifying indicia 12a, 12b, 12c, 12d and 12e corresponding to the numbers “1”, “2”, “3”, “4” and “5”, thereby forming a sequential pattern of the numbers “1” through “5” respectively. In set 10, the plurality of baby bottles is five. Thus, the parent or other care-giver easily can monitor and visually track the set of baby bottles and quickly determine whether one or more of the baby bottles is missing. In addition, the parent or other care-giver also can determine very simply which specific baby bottle is missing by observation of the unique identifying indicia on each of the bottles. The type of sequential pattern shown in FIG. 1 also aids the parent or care-giver in ascertaining the length of time a particular baby bottle has been missing by simple notation of the unique idenitfying indicia on the missing bottle. For example, if baby bottle 11a having the unique identifying indica “1” was the first bottle distributed to the toddler at 7:00 AM and subsequent bottles were distributed sequentially in four hour intervals, then the parent or care-giver simply has to note the identifying indicia on the current bottle to be given to the toddler and calculate the time differential. This sequential pattern also can assist the toddler in the learning of numbers.

FIG. 2 shows a set 20 of a plurality of sippy cups 21, each sippy cup being provided with a unique identifying indicia 22 in the form of a sequential pattern conforming to the days of the week. More specifically, a plurality of sippy cups 21a, 21b, 21c, 21d, 21e, 21f and 21g is shown, each of the plurality of sippy cups being provided with a unique identifying indicia 22a, 22b, 22c, 22d, 22e, 22f, and 22g corresponding to the days of the week “Monday”, “Tuesday”, “Wednesday”, “Thursday”, “Friday”, “Saturday” and “Sunday” respectively. The use of the “days of week” sequential pattern can be of particular assistance to the parent or care-giver when the sippy cups 21 are given to the toddler on the specific day of the week. This sequential pattern also can assist the toddler in the learning of days of the week.

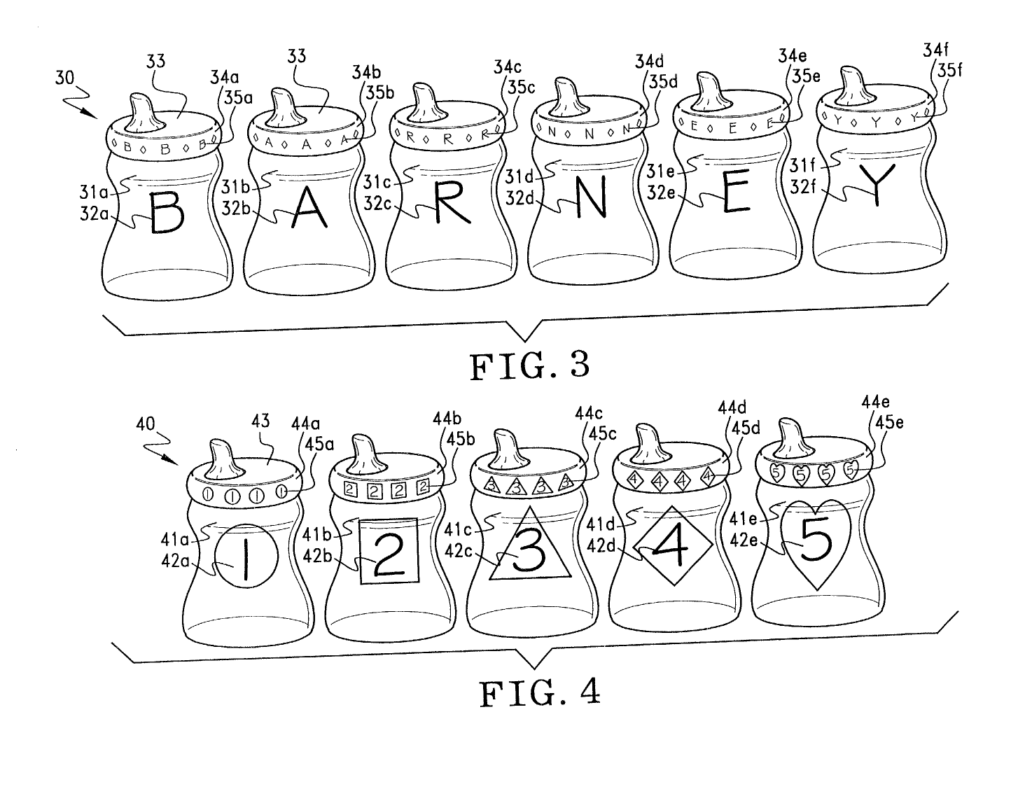

FIG. 3 shows a set 30 of a plurality of sippy cups 31, each sippy cup being provided with a unique identifying indicia 32 in the form of a sequential pattern of letters which spell the name “BARNEY”, a popular children's character. More specifically, a plurality of sippy cups 31a, 31b, 31c, 31d, 31e and 31f is shown, each of the plurality of sippy cups being provided with a unique identifying indicia 32a, 32b, 32c, 32d, 32e and 32f corresponding to the letters “B”, “A”, “R”, “N”, “E” and “Y” respectively. Each of the plurality of cups also may be provided with a purple dinosaur depicting the character “Barney”. In FIG. 3, each of the sippy cups 31 comprises a lid 33 having a collar 34 about the circumference of the lid. A second unique identifying indicia 35 corresponding to indicia 32 is provided on the collar 34. Specifically, collar 34a is provided with indicia 35a in the form of a “B” corresponding to indicia 32a. Similarly, collars 34b, 34c, 34d, 34e and 34f are provided with indicia 35b, 35c, 35d, 35e and 35f corresponding to the letters “A”, “R”, “N”, “E” and “Y” respectively. In this manner, each lid 33 can be matched to its corresponding cup 31. This sequential pattern also can assist the toddler in the spelling names as well as matching the identifying and matching the letters provided on the cups 31 and lids 33.

FIG. 4 shows a set 40 of a plurality of sippy cups 41, each sippy cup being provided with a unique identifying indicia 42 in the form of a combination of shapes and a sequential pattern of numbers. More specifically, a plurality of sippy cups 41a, 41b, 41c, 41d and 41e is shown, each of the plurality of sippy cups being provided with a unique identifying indicia 42a, 42b, 42c, 42d and 42e. The sequential pattern utilizes a combination of shapes and numbers which not only uniquely identify each cup 41 but also assist the toddler with learning numbers and shapes as well as counting skills. Referring to FIG. 4, indicia 42a is a single “circle” having the numeral “1” therein, indicia 42b is two “squares”, each “square” having the numeral “2” therein, indicia 42c is three “triangles”, each “triangle” having the numeral “3” therein, indicia 42d is four “diamonds”, each “diamond” having the numeral “4” therein, and indicia 42e is five “hearts”, each “heart” having the numeral “5” therein. Each of the sippy cups 41 comprises a lid 43 having a collar 44 about the circumference of the lid. A second unique identifying indicia 45 corresponding to indicia 42 is provided on the collar 44. Thus, indicia 45a is a “circle”, indicia 45b is a “square”, indicia 45c is a “triangle”, indicia 45d is a “diamond” and indicia 45e is a “heart”.

Although several sequential patterns have been shown in FIGS. 1 to 4, it is to be understood that the present invention contemplates the use of any sequential pattern of identifying indicia or combinations of sequential patterns of identifying indicia are contemplated to be within the scope of the present invention.

Each of the plurality of drinking cups in a particular set can be provided with a unique identifying indicia from a sequential pattern by any means as will be well known to those skilled in the art. Suitable means for providing each drinking cup with a unique identifying indicia include, for example, applying to the drinking cup an adhesive label having a unique identifying indicia printed thereon, extrusion molding the unique identifying indicia during the manufacture of the drinking cup, inscribing the unique identifying indicia onto the outside wall and/or the inside wall the drinking cup, such as by machining, chemical or laser etching of the drinking cup surface, insert molding the unique identifying indicia within the wall of the cup or onto the wall of the cup, as well as pad printing, silk screening printing, hot stamping or plain printing the unique identifying indicia to the drinking cup.

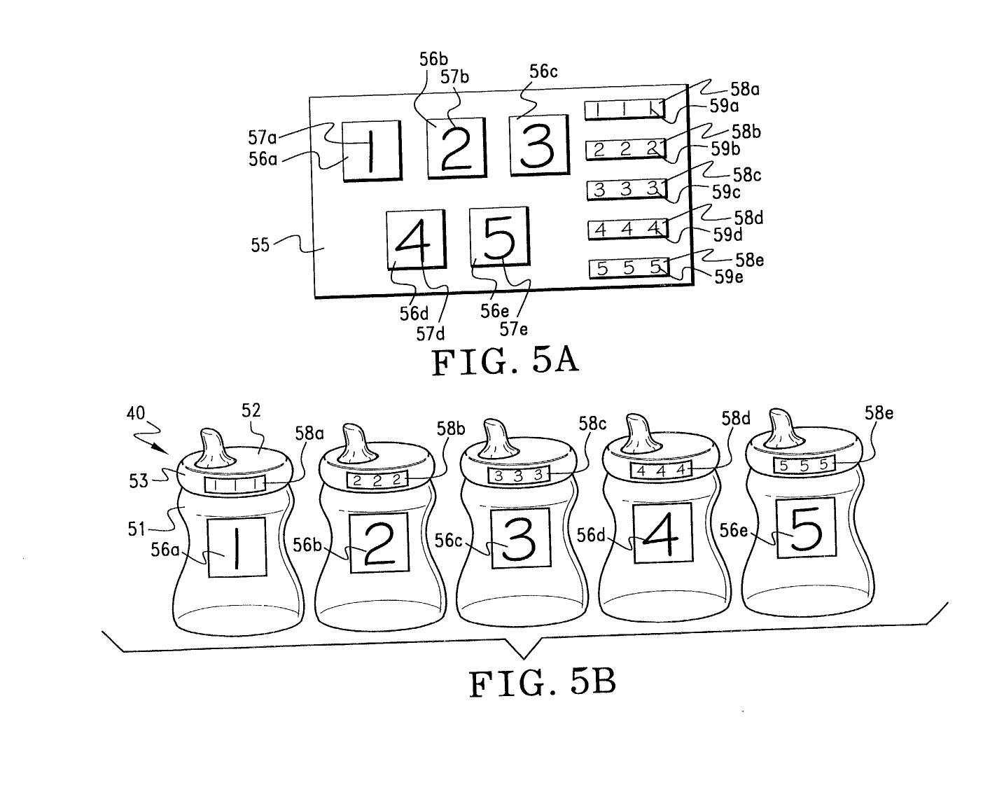

Referring to FIG. 5A, a strip 55 of adhesive labels 56 is shown having a unique identifying indicia 57. Specifically, each label 56a, 56b, 56c, 56d and 56e has a unique identifying indicia 57a, 57b, 57c, 57d and 57e corresponding to the numbers “1”, “2”, “3”, “4” and “5”, thereby forming a sequential pattern of the numbers “1” through “5” respectively. The strip 55 also has a second set of adhesive labels 58, each label having a unique identifying indicia 59 corresponding to unique identifying indicia 57. Thus, each of the adhesive labels 58a, 58b, 58c, 58d and 58e having a unique identifying indicia 59a, 59b, 59c, 59d and 59e which correspond to unique identifying indicia 57a, 57b, 57c, 57d and 57e.

FIG. 5B shows a set 50 of a plurality of drinking cups 51 each having lid 52 and collar 53. Adhesive labels 56a, 56b, 56c, 56d and 56e are applied to the corresponding drinking cups 51a, 51b, 51c, 51d and 51e, thereby providing each drinking cup 51 with a unique identifying indicia 57a, 57b, 57c, 57d and 57e. Adhesive labels 58a, 58b, 58c, 58d and 58e are applied to the corresponding collars 53a, 53b, 53c, 53d and 53e, thereby providing each collar with a unique identifying indicia 59a, 59b, 59c, 59d and 59e.

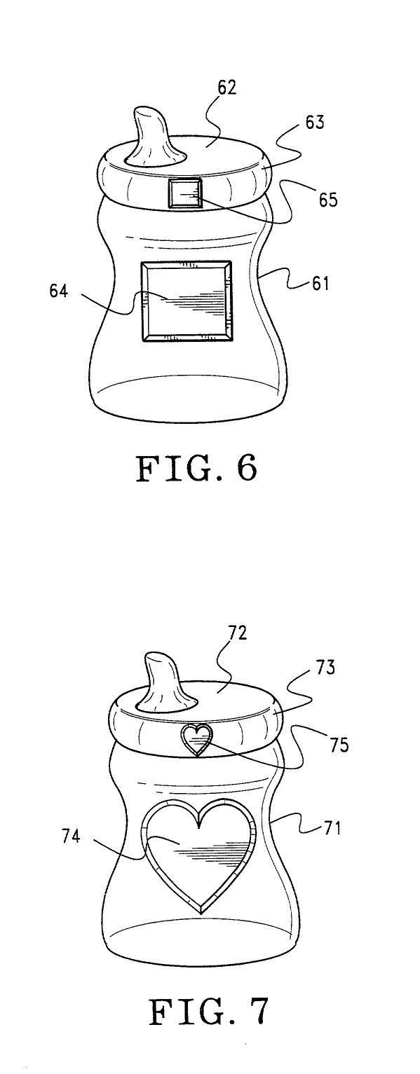

FIGS. 6 and 7 illustrate to other methods for providing a drinking cup with a unique identifying indicia. FIG. 6 shows a drinking cup 61 having a lid 62 and collar 63 having a first unique identifying indicia 64 machined molded within the drinking cup 61 and a second unique identifying indicia 65 machine molded within the collar 63. FIG. 7 shows a drinking cup 71 having a lid 72 and collar 73 wherein a first unique identifying indicia 74 is inscribed into the drinking cup 71 and a second unique identifying indicia 75 is inscribed into the collar 73.

While particular embodiments of the invention have been described, it will be understood, of course, that the invention is not limited thereto, and that many obvious modifications and variations can be made, and that such modifications and variations are intended to fall within the scope of the appended claims.

What is claimed is:

1. A drinking cup identification system comprising:
(a) a set of a plurality of drinking cups and
(b) a sequential pattern of indicia, said sequential pattern of indicia composed of a plurality of first unique identifying indicia corresponding to said plurality of drinking cups,
wherein each of said plurality of drinking cups is provided with a unique identifying indicia selected from said plurality of first unique identifying indicia in such a manner that each of said plurality of drinking cups can be easily identified and that said set of a plurality of drinking cups can be visually monitored to determine whether any of the plurality of drinking cups is missing from said set.

2. The drinking cup identification system in accordance with claim 1, wherein each of said plurality of drinking cups further comprises a lid which is securely fastenable to said drinking cup.

3. The drinking cup identification system in accordance with 2, wherein said plurality of drinking cups are selected from the group consisting of baby bottles and sippy cups.

4. The drinking cup identification system in accordance with 2, further comprising a plurality of second unique identifying indicia corresponding to said first unique identifying indicia, wherein each of lid of said plurality of drinking cups is provided with a second unique identifying indicia corresponding to said first unique identifying indicia provided on each of said plurality of drinking cups.

5. The drinking cup identification system in accordance with 1, wherein said sequential pattern is composed of a series of unique identifying indicia selected from the group consisting of a series of numbers, a series of alphabet letters, a series of letters which spell a name, a series of related cartoon characters, the days of the week, and a series of geometric shapes, symbols or designs.

6. The drinking cup identification system in accordance with 5, wherein said sequential pattern comprises a combination of at least two series of unique identifying indicia.

7. The drinking cup identification system in accordance with 2, wherein said sequential pattern is composed of a series unique identifying indicia selected from the group consisting of a series of numbers, a series of alphabet letters, a series of letters which spell a name, a series of related cartoon characters, the days of the week, and a series of geometric shapes, symbols or designs.

8. The drinking cup identification system in accordance with 7, wherein said sequential pattern comprises a combination of at least two series of unique identifying indicia.

9. The drinking cup identification system in accordance with 1, wherein said sequential pattern of indicia is printed on adhesive labels, each of said adhesive labels being adapted for application onto each of said plurality of drinking cups.

10. The drinking cup identification system in accordance with 4, wherein said sequential pattern of indicia is printed on adhesive labels, each of said adhesive labels being adapted for application onto each of said plurality of drinking cups and said lids

11. The drinking cup identification system in accordance with 1, wherein said sequential pattern of indicia is machine molded into each of said plurality of drinking cups.

12. The drinking cup identification system in accordance with 2, wherein said sequential pattern of indicia is machine molded into each of said plurality of drinking cups and into each of said lids.

13. The drinking cup identification system in accordance with 1, wherein said sequential pattern of indicia is inscribed by etching onto each of said plurality of drinking cups.

14. The drinking cup identification system in accordance with 2, wherein said sequential pattern of indicia is inscribed by etching onto each of said plurality of drinking cups and into each of said lids.

15. A drinking cup identification system comprising:
(a) a set of a plurality of drinking cups, each of said drinking cups having a lid securely fastenable thereto, and
(b) a sequential pattern of indicia, said sequential pattern of indicia comprising a plurality of first unique identifying indicia corresponding to said plurality of drinking cups and a plurality of second unique identifying indicia corresponding to said first unique identifying indicia,
wherein each of said plurality of drinking cups is provided with a unique identifying indicia selected from said plurality of first unique identifying indicia and each of said lids is provided with a unique identifying indicia selected from said plurality of second unique identifying indicia in such a manner that each of said plurality of drinking cups and lids can be easily identified and that said set of a plurality of drinking cups can be visually monitored to determine whether any of the plurality of drinking cups is missing from said set.

16. The drinking cup identification system in accordance with 15, wherein said plurality of drinking cups are selected from the group consisting of baby bottles and sippy cups.

17. The drinking cup identification system in accordance with 15, wherein said sequential pattern is composed of at least one series of unique identifying indicia selected from the group consisting of a series of numbers, a series of alphabet letters, a series of letters which spell a name, a series of related cartoon characters, the days of the week, and a series of geometric shapes, symbols or designs.

18. The drinking cup identification system in accordance with 15, wherein said sequential pattern of indicia is printed on adhesive labels, each of said adhesive labels being adapted for application onto each of said plurality of drinking cups and lids.

19. The drinking cup identification system in accordance with 15, wherein said sequential pattern of indicia is machine molded into each of said plurality of drinking cups and lids.

20. The drinking cup identification system in accordance with 15, wherein said sequential pattern of indicia is inscribed by etching onto each of said plurality of drinking cups and lids.
